(19) United States
(12) Patent Application Publication
(10) Pub. No.: US 2010/0022673 A1
(43) Pub. Date: Jan. 28, 2010

(54) PROTON-CONDUCTIVE FILM, FUEL CELL COMPRISING THE SAME AND METHOD FOR PRODUCING THE SAME

(75) Inventors: Norikazu NISHIYAMA, Osaka (JP); Masaki TAKAOKA, Kyoto (JP); Akira KAMISAWA, Kyoto (JP)

Correspondence Address: HAMRE, SCHUMANN, MUELLER & LARSON, P.C., P.O. BOX 2902, MINNEAPOLIS, MN, 55402-0902, US

(73) Assignees: ROHM CO., LTD., Kyoto-shi (JP); OSAKA UNIVERSITY, Osaka (JP)

(21) Appl. No.: 12/575,959

(22) Filed: Oct. 8, 2009

Related U.S. Application Data
(62) Division of application No. 11/331,384, filed on Jan. 12, 2006, now abandoned.

(30) Foreign Application Priority Data
Jan. 13, 2005 (JP) 2005-006097

(51) Int. Cl. C08J 5/20

(52) U.S. Cl. 521/27

(57) ABSTRACT

The proton-conductive film comprises a mesoporous thin film that has, as the principal component thereof, a crosslinked structure having a metal-oxygen skeleton with an acid group bonding to at least a part thereof, in which the pores are periodically aligned and the inner wall of the pores is coated with a silanol group.

### CROSS-REFERENCE TO RELATED APPLICATIONS

This application is a Division of application Ser. No. 11/331,384, filed Jan. 12, 2006, which application is incorporated herein by reference.

### BACKGROUND OF THE INVENTION

The present invention relates to a proton-conductive film, a fuel cell comprising it, and a method for producing it. In particular, the invention relates to a proton-conductive film for direct methanol fuel cells that stably act for a long period of time.

Fuel cells have a high power-generating efficiency and are good for environmental protection. Recently, therefore, fuel cells have become specifically noted as a power-generating device in the next generation capable of contributing to solution of various environmental problems and energy problems that are now serious social issues.

In general, fuel cells are grouped into some types depending on the kind of the electrolyte used therein. Of those, a direct methanol fuel cell (hereinafter referred to as DMFC) is specifically noticed, in which a liquid fuel methanol is directly fed to induce electrochemical reaction therein and which may be therefore driven as such not requiring any modifier.

In DMFC, a liquid fuel having a high energy density may be used, and since it does not require an modifier, its system could be compact. Accordingly, DMFC is specifically noticed as a portable power source substitutable for lithium ion cells for portable devices.

In DMFC, methanol is directly reacted on an anode side to form water on a cathode side, according to the following electrochemical reaction:

Anode: CH₃OH+H₂O→CO₂+6H⁺+6e⁻

Cathode: 6H⁺+⅔ O₂+6e⁻→3H₂O

In this, a proton-conductive film acts to transfer the proton formed on the anode side to the cathode side. The proton transfer occurs, as coordinated with an electron flow. In DMFC, for obtaining a high output, or that is, a high current density, a sufficient amount of proton conduction must be attained at a high speed. Accordingly, the quality of the proton-conductive film has a significant influence on the quality of DMFC. In addition, the proton-conductive film has not only the role of proton conduction but also additional two roles for electrical insulation between anode and cathode and for fuel barrier to protect the fuel supplied onto the anode side from being leaked away into the cathode side.

Heretofore, fluororesins such as perfluorocarbonsulfonic acid polymer (Nafion®) are known as high-function proton-conductive films (Patent Reference 1).

In these proton-conductive films, some sulfonic acid groups aggregate to form a reverse-micelle structure, and therefore the films are problematic in that they readily swell and readily undergo methanol crossover. Specifically, a proton path is formed in the reverse-micelle structure part that comprises sulfonic acid groups bonding to a perfluoro chain.

As swelling, these fluororesin films tend to undergo methanol crossover, and therefore the proton-conductive structure in the films may change, and methanol could not be satisfactorily used. Accordingly, the films of the type are problematic in that they may cause cathode potential reduction, that stable electrode reaction could not be attained and that the power-generating efficiency is insufficient.

Since the films repeatedly swell, there is still another problem in that their mechanical strength may readily lower. Furthermore, a sulfonic acid group of a strong acid is used in the films, and therefore novel electrolytic films having better chemical resistance are desired.
[Patent Reference 1] JP-A 7-90111

### SUMMARY OF THE INVENTION

The invention is made in consideration of the above-mentioned situation in the art, and its one object is to provide a stable and reliable proton-conductive film for fuel cells capable of preventing crossover while keeping proton conductivity.

Another object of the invention is to provide a high-efficiency fuel cell having a high mechanical strength and capable of acting stably for a long period of time.

The proton-conductive film of the invention is attained with paying specific attention to an inorganic material, mesoporous silica having a regular porous structure. Since the film is formed of such an inorganic material, it may have good heat resistance and good chemical resistance, and, in addition, improving its proton conductivity may be expected by modifying the inside of the pores or the skeleton of the film with a proton donor such as a sulfonic acid group or a phosphoric acid group.

The proton-conductive film of the invention comprises a mesoporous thin film that has, as the principal component thereof, a crosslinked structure having a metal-oxygen skeleton with an acid group bonding to at least a part thereof, in which the pores are periodically aligned and the inner wall of the pores is coated with a modifying group.

Having the constitution of the type, the pore surface in the film is coated with a modifying group such as a silanol group or a P-OH group and, in addition, the crosslinked structure that surrounds the pores has a tough metal-oxygen skeleton. Accordingly, in the film, the skeleton structure itself is tough and does not swell, and the pore size may be kept constant, and the methanol crossover may be reduced. To that effect, the proton-conductive film of the invention has a high reliability. In addition, the pore size may be small, but the pore surface is coated with a modifying group such as a silanol group, and therefore the proton conductivity of the film may be prevented from being lowered. Accordingly, the crossover in the film may be reduced not lowering the proton conductivity of the film.

In the proton-conductive film of the invention, the crosslinked structure principally comprises a silicon-oxygen bond.

Having the constitution of the type, the invention provides a proton-conductive film that is stable and has good heat resistance.

In the proton-conductive film of the invention, the modifying group includes a silanol group.

Having the constitution of the type, the pore size in the film may be small, but the pore surface is coated with a silanol group, and therefore the proton conductivity of the film may be prevented from being lowered. Accordingly, the crossover in the film may be reduced not lowering the proton conductivity of the film.

In the proton-conductive film of the invention, the modifying group includes a P—OH group.

Having the constitution of the type, the pore size in the film may be small, but the pore surface is coated with a P—OH group, and therefore the proton conductivity of the film may be prevented from being lowered. Accordingly, the crossover in the film may be reduced not lowering the proton conductivity of the film.

Preferably in the proton-conductive film of the invention, the crosslinked structure is so designed that columnar pores are periodically aligned in the thickness direction of the mesoporous silica thin film.

Having the constitution of the type, the columnar pores are periodically aligned as passing through the thickness direction of the mesoporous silica thin film, and therefore proton paths may be formed in the thickness direction, and the proton paths may be shortened whereby the film enables high-speed proton conduction through it. In addition, the pore size in the film can be controlled, and therefore, when the pores therein are controlled to have a suitable pore size, then the film may prevent methanol crossover therein.

The proton-conductive film of the invention may have a thickness of at most 10 μm.

Having the constitution, the invention may provide a proton-conductive film that is thin and has a high mechanical strength, and the proton conductivity in the fuel cell comprising the film may be increased.

Preferably, the acid group in the proton-conductive film is a sulfonic acid group.

Having the constitution, since the film has a sulfonic acid group of a strong acid, its proton conductivity is high.

In the proton-conductive film of the invention, the silanol group may have a multi-branched structure.

Accordingly, the pore size in the film may be reduced. In addition, the pore size may be suitably controlled by varying the number of the branches of the multi-branched structure.

The fuel cell of the invention comprises the above-mentioned proton-conductive film.

A method for producing the proton-conductive film of the invention comprises a step of preparing a precursor solution containing a metal-oxygen derivative and a surfactant, a crosslinking step of crosslinking the precursor solution to form a crosslinked structure, a removing step of decomposing and removing the surfactant from the crosslinked structure obtained in the crosslinking step to thereby form a mesoporous thin film which has, as the principal component thereof, a crosslinked structure having a metal-oxygen skeleton with an acid group bonding to at least a part thereof, and in which the pores are periodically aligned, and a step of adding a modifying group to the surface of the pores.

According to the constitution of the type, a modifying group such as a silanol group or a P—OH group may be added to the inner wall of the pores in the film, and a stable and tough structure maybe formed in the film. In addition, by controlling the amount and the composition of the surfactant, the pore size may be readily controlled. Further, the skeleton structure itself is tough and does not swell, and the pore size may be kept constant, and the methanol crossover may be reduced. To that effect, a proton-conductive film having a high reliability can be readily produced.

In this, controlling the molecular length is effective, and the molecular length may be controlled as a part of the composition of the film.

In the method of producing a proton-conductive film of the invention, the addition step includes a step of silylating the mesoporous thin film to thereby modify the surface of the pores with a silyl group, and a calcining step of calcining the mesoporous thin film to thereby convert the OH group in the surface of the pores to a silanol group.

According to this constitution, the silanol group in the inner wall of the pores of the mesoporous thin film may be silylated and the pores may be coated with a silyl group, and the film may be calcined to form a silanol group to coat the pores. According to this method, an Si—O bond may be formed in the inner wall of the pores, and the pore size may be reduced, and therefore a tough and reliable mesoporous thin film may be formed.

In the method of producing a proton-conductive film of the invention, the addition step includes a step of phosphorylating the mesoporous thin film to thereby modify the surface of the pores with a P—OH group, and a calcining step of calcining the mesoporous thin film to thereby make the surface of the pores have a P—OH group.

According to this constitution, the inner wall of the pores in the mesoporous thin film may be modified with a P—OH film and then the group may be converted into a P—O group by calcination. According to this method, a P—O bond may be formed in the inner wall of the pores, and the pore size may be thereby reduced and a tough and reliable mesoporous thin film may be formed.

In any case of silylation and phosphorylation, it is desirable that the pore size is not smaller than 0.5 nm. If the pore size is smaller than 0.5 nm, then the proton conductivity of the film may lower.

In the method of producing a proton-conductive film of the invention, the addition step may comprise the modifying step and the calcining step that are carried out plural times to thereby control the pore size to a desired one.

According to this constitution, the OH group in the inner wall of the pores in the mesoporous thin film may be coated with a silyl group through silylation, and it may be further calcined to form a silanol group, and these steps may be repeated plural times to form a silanol group having a multi-branched structure. According to the method, therefore, a multi-branched structure that comprises plural stages of an Si—O bond formed therein may be formed in the inner wall of the pores, and the pore size may be reduced, and a tough and reliable mesoporous thin film may be formed.

In the method of producing a proton-conductive film of the invention, the modification step may comprise a step of contacting the pore surface with a vapor of trimethylethoxysilane.

According to this method, a reliable mesoporous thin film may be formed.

More preferably, the method for producing a proton-conductive film includes a step of supplying the above-mentioned precursor solution to the surface of a substrate, in which the crosslinking step includes a step of crosslinking the precursor solution on the surface of the substrate.

According to this constitution, a collector structure may be formed without forming any specific electrode, and therefore, a compact fuel cell may be produced in a simple manner.

Also preferably in the method for producing a proton-conductive film, the pore size in the porous conductor is from 10 nm to 10 μm.

According to this constitution, a fuel metal may well pass through the mesoporous silica thin film, and the film is easy to form. If a conventional fluororesin film is too much thinned, then it causes a problem in that it may readily absorb water to creep when the ambient temperature rises, and therefore its strength may lower. However, the proton-conductive film produced according to the method of the invention is free from the problem since it has a crosslinked structure that contains a silicon-oxygen skeleton.

More preferably, the pore size is from 50 nm to 1 μm for better methanol permeability and higher strength of the film.

Also preferably, the method for producing a proton-conductive film includes a step of preparing a precursor solution containing a silica derivative and a surfactant, a crosslinking step of crosslinking the precursor solution to form a crosslinked structure, and a step of decomposing and removing the surfactant, and it produces a mesoporous thin film which has, as the principal component thereof, a crosslinked structure having a silicon-oxygen skeleton with an acid group bonding to at least a part thereof, and in which the pores are periodically aligned.

According to this constitution, the crosslinked structure is easy to form in the film.

Also preferably, in the method for producing a proton-conductive film, the decomposition and removal step includes a step of calcining the crosslinked structure and removing the surfactant.

According to this constitution, the intended mesoporous thin film is easy to produce, in which the pores are periodically aligned.

Also preferably, the method for producing a proton-conductive film includes a step of exposing the precursor solution-supplied substrate to a vapor of TEOS prior to the removal of the surfactant to thereby increase the density of the silicon-oxygen skeleton in the film.

According to the method, the density of the silicon-oxygen skeleton in the film may be increased and the amount of oxygen introduced into the film may be increased.

Also preferably, in the method for producing a proton-conductive film includes, the step of forming the crosslinked structure includes a step of extracting the surfactant with an acid.

Accordingly, the surfactant may be extracted away, not requiring a high-temperature step, and therefore the surfactant extraction may be attained with no release of the acid group introduced into the film in the silylation step.

Specifically, when the silylation is effected prior to calcination, then there may be a possibility that the mercapto group may drop away by calcination. In this embodiment, however, the surfactant may be readily removed through extraction with acid.

Also preferably, the method for producing a proton-conductive film includes a step of exposing the precursor solution-supplied substrate to a vapor of MPTMS (Mercaptopropyltrimethoxysilane) prior to the surfactant removal to thereby silylate the silicon-oxygen structure in the film.

According to the method, an acid group may be introduced into the micropores of the silicon-oxygen skeleton, and therefore a proton-conductive film having high proton conductivity may be formed and the amount of the acid group introduced into the film may be increased.

Also preferably, in the method for producing a proton-conductive film, the substrate is formed of porous carbon.

According to this constitution, the film produced may have good conductivity and the adhesiveness of the substrate to the oxygen-silicon crosslinked structure is good.

Also preferably, in the method for producing a proton-conductive film, the substrate is formed of porous silicon.

Also preferably, the method for producing a proton-conductive film includes a step of preparing a precursor solution that contains water, ethanol, hydrochloric acid, surfactant and TEOS, a step of applying the precursor solution to a substrate, a step of removing the surfactant to thereby form a crosslinked structure having a silicon-oxygen skeleton, a step of silylating the crosslinked structure to thereby form a crosslinked structure having a mercapto group in the silicon-oxygen skeleton therein, and a step of oxidizing the mercapto group in the crosslinked structure to thereby form a crosslinked structure having a sulfonic acid group.

According to this method, the porosity and the formation of proton paths may be controlled by controlling the compositional ratio of the precursor solution, and controlling the conditions for silylation and oxidation. Accordingly, it is possible to control the permeability of methanol and proton through the film. In addition, a mercapto group is once introduced and this is then oxidized, whereby the density of the introduced sulfonic acid group in the film may be increased.

Also preferably, the step of applying the precursor solution to a substrate includes a step of dipping a substrate in the precursor solution and pulling it up at a desired speed.

Also preferably, the applying step includes a step of successively and repeatedly applying the precursor solution to a substrate.

More preferably, the applying step includes a spin-coating step of dropping the precursor solution onto a substrate and spinning the substrate.

According to the method, the film thickness and the porosity may be controlled, whereby the methanol permeability and the proton conductivity of the film may be readily controlled, and the producibility of the intended proton-conductive film is high.

According to the method of the invention, the frequency of the silylation step and the calcination step to be repeated may be controlled, whereby the pore size in the film may be more favorably controlled.

As described hereinabove, the proton-conductive film of the invention comprises a crosslinked structure having a tough metal-oxygen skeleton in which the inner wall of the pores is modified with a silanol group, and therefore in the film, the skeleton structure itself is tough and does not swell. In addition, since the pore size may be small and may be kept constant, and the methanol crossover in the film may be reduced not reducing the proton conductivity of the film. To that effect, the invention provides a proton-conductive film of high reliability.

### BRIEF DESCRIPTION OF THE DRAWINGS

FIG. 1 is a graphical view showing the constitution of a proton-conductive film produced according to the method of an embodiment of the invention.

FIGS. 2A and 2B are enlarged explanatory views of the essential parts of the proton-conductive film.

FIGS. 3A to 3F show a process of producing a fuel cell that comprises the proton-conductive film of the Embodiment 1 of the invention.

FIG. 4 shows a flowchart of producing the proton-conductive film of the Embodiment 1 of the invention.

FIG. 5 is a structure explanatory view of an electrophoresis process in the Embodiment 1 of the invention.

FIGS. 6A and 6B show the spacing data of the proton-conductive films of the Embodiment 1 of the invention (phosphorylation) (silylation).

FIG. 7 shows the methanol adsorption data after phosphorylation of the proton-conductive films of the Embodiment 1 of the invention.

FIG. 8 shows the methanol adsorption data after silylation of the proton-conductive films of the Embodiment 1 of the invention.

FIG. 9 shows the FT-IR spectrum data of the proton-conductive films of the Embodiment 1 of the invention.

FIG. 10 shows the methanol adsorption data after silylation and calcination of the proton-conductive films of the Embodiment 1 of the invention.

FIG. 11 shows the conductivity data before and after silylation of the proton-conductive films of the Embodiment 1 of the invention.

FIG. 12 shows the conductivity data after repeated silylation of the proton-conductive films of the Embodiment 1 of the invention.

FIG. 13 shows a flowchart of producing the proton-conductive film of the Embodiment 2 of the invention.

FIGS. 14A to 14G show a process of producing a fuel cell that comprises the proton-conductive film of the Embodiment 3 of the invention.

### DETAILED DESCRIPTION OF THE PREFERRED EMBODIMENTS

Embodiments of the proton-conductive film of the invention are described in detail with reference to the drawings attached hereto.

### Embodiment 1

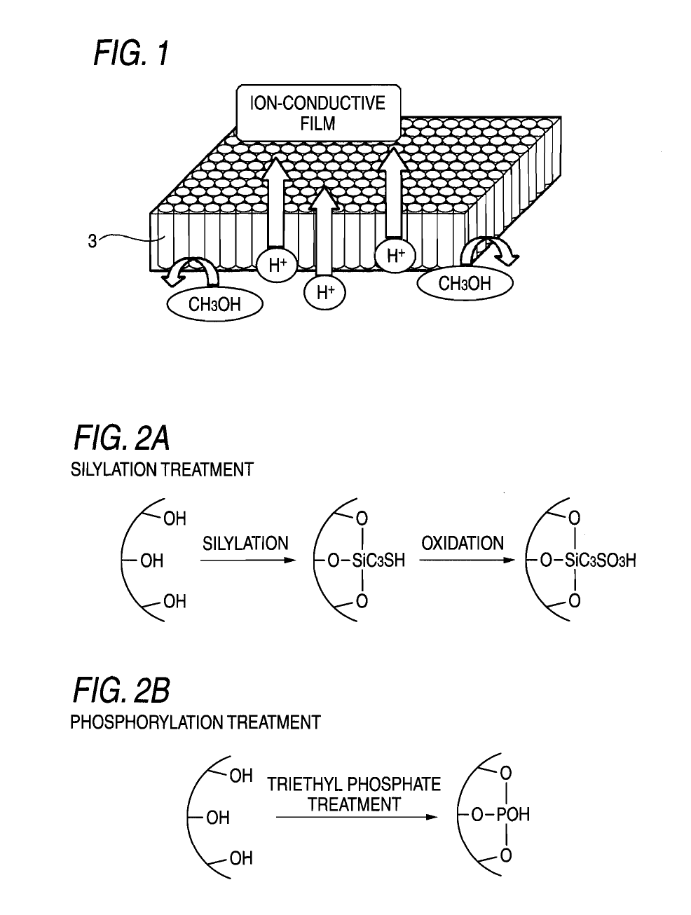

As in FIG. 1 showing its graphical view, one embodiment of the proton-conductive film of the invention is characterized by comprising a mesoporous film that has, as the principal component thereof, a crosslinked structure having a metal-oxygen skeleton with an acid group bonding to at least a part thereof, in which columnar pores are aligned in the thickness direction of the film to constitute proton paths with the inner wall thereof being coated with a silanol group. The presence of the silanol group reduces the pore size of the pores that constitute the proton paths 3, whereby the methanol perviousness through the film may be reduced, while, on the other hand, the silanol group does not lower the proton conductivity of the film.

FIG. 2A is an enlarged schematic view showing an addition step of a silanol group, in which a silanol group is introduced into the columnar pore to be a proton path 3, and the pore size is reduced to prevent methanol crossover and the proton conductivity through the path is thereby increased.

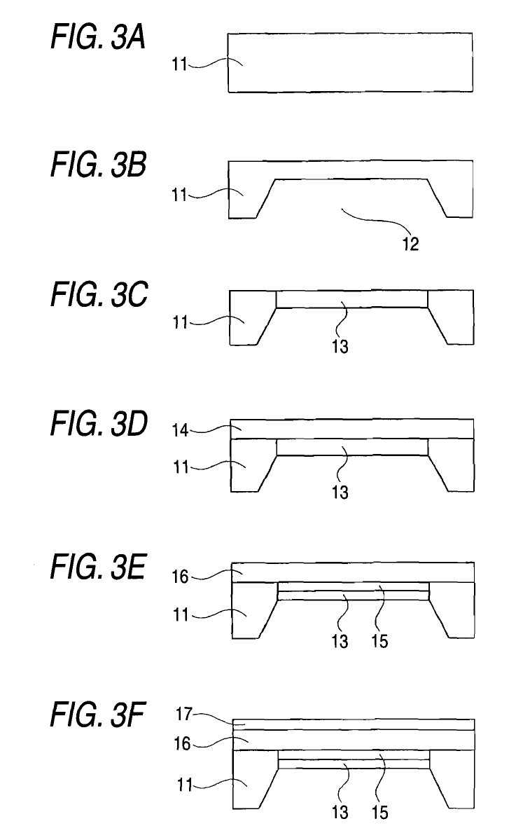

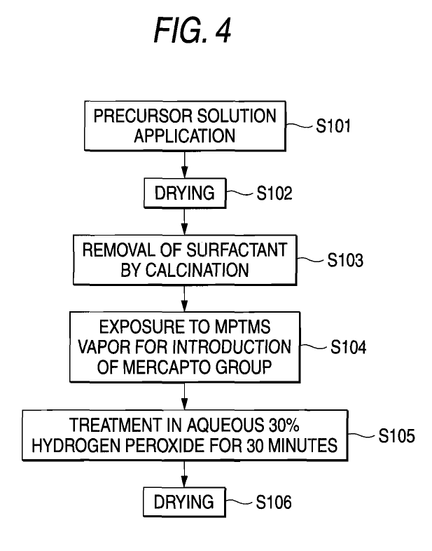

Next described is a method of constructing a membrane electrode assembly (MEA) of a fuel cell that comprises the above proto-conductive film. FIGS. 3A to 3F is a process explanatory view; and FIG. 4 is a flowchart of a step of forming a proton-conductive film.

As in FIG. 3A, an n-type silicon substrate 11 with a main face of (100) having a specific resistivity of 5×10¹⁸ cm⁻³ is prepared.

Next, as in FIG. 3B, a resist pattern having an opening in a cell-forming region is formed on the back side of the silicon substrate, and anisotropically etched with a TMAH solution at 83° C. to a desired depth to thereby form an opening 12 for forming a thin-wall part.

After it, as in FIG. 3C, this is subjected to anodic oxidation of silicon, whereby the entire thin-wall part of the silicon substrate 11 having a pore size of from 10 nm to 1 μm is made into a porous silicon 13.

Further, a mesoporous silica thin film (proton-conductive film) is formed on the porous silicon 13, in which columnar pores are periodically aligned to be vertical to the surface of the silicon substrate.

The mesoporous silica thin film is formed as follows: A silica derivative, TEOS (tetraethoxysilane), a surfactant, cationic cetyltrimethylammonium bromide (C₁₆TAB: C₁₆H₃₃N⁺(CH₃)₃Br), and an acid catalyst, hydrochloric acid (HCl) are dissolved in a mixed solvent of H₂O/Et-OH (water-alcohol) to prepare a precursor solution in a mixer chamber. The molar ratio of the components as mixed to constitute the precursor solution is H₂O:Et-OH:HCl:C₁₆TB:TEOS=100:25:0.7:0.9:8. The mixture solution is applied onto the surface of the silicon substrate with the porous silicon 13 formed therein as in FIG. 3B, using a spinner (FIG. 4, step 101), and dried at 90° C. for 5 minutes (FIG. 4, step 102), whereby the silica derivative is polymerized through hydrolytic polycondensation (pre-crosslinking step) to form a periodic self-aggregate of the surfactant.

The self-aggregate forms a rod-like micelle structure with plural molecules aggregated therein, in which one molecule is C₁₆H₃₃N⁺(CH₃)₃Br; and with the increase in the aggregation degree thereof as a result of the increase in the concentration thereof, the parts from which the methyl group is dropped off form pores and the pores are aligned to constitute a crosslinked structure.

Then, after washed with water and dried, this is heated and calcined in a nitrogen atmosphere at 500° C. for 6 hours (FIG. 4, step 103), and the template surfactant is completely pyrolyzed and removed to give a pure mesoporous silica thin film. Then, this is treated in an MPTMS vapor at 180° C. for 4 hours (FIG. 4, step 104), to thereby form a silicon-oxygen crosslinked structure with a mercapto group bonding thereto. After it, this is heat-treated in aqueous 30% hydrogen peroxide for 30 minutes (FIG. 4, step 105), and dried (FIG. 4, step 106).

Further, the inside of the pores is modified with trimethylethoxysilane; and, as in FIG. 2, this is silylated to from a silyl group, and then calcined at 600° C. to decompose the organic group to thereby form a silanol group.

In the manner as above, a proton-conductive film 14 is formed as in FIG. 3D. The proton-conductive film is so constituted that columnar pores are aligned therein in the thickness direction of the film.

FIG. 1 is a structure explanatory view showing a cross section of this condition of the film. As is obvious from this drawing, columnar pores are formed in the film and the film is a porous thin film having a skeleton structure that contains a large number of such pores.

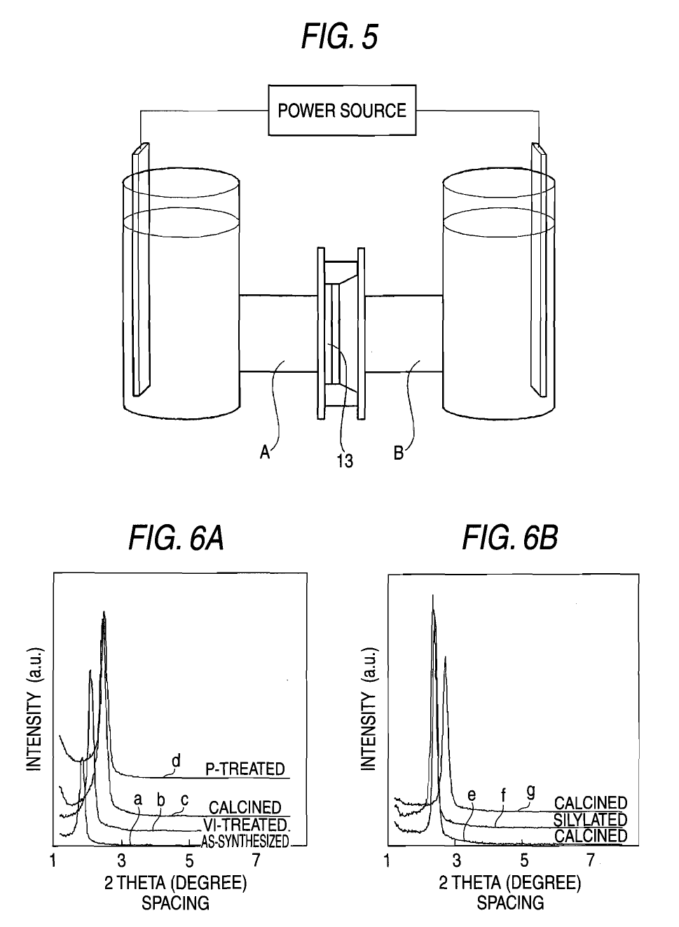

Next, platinum-carrying carbon, 5 mas. % Nafion® solution and ethanol are mixed and ultrasonically dispersed to prepare a dispersion A. The dispersion is kept in contact with the back of the porous silicon 13, while an aqueous 0.1 M perchloric acid solution B is disposed on the other side thereof, and a voltage is applied to it in that condition, and as in FIG. 5, a catalyst layer 15 is formed according to an electrophoresis process. In this stage, Nafion® adheres to the surface of the porous silicon 13 and serves as a dispersant, and a platinum-containing catalyst layer 15 is thereby formed.

Further, as in FIG. 3E, a catalyst layer 16 is formed also on the surface side of the proton-conductive film 14 in he same manner as above.

Then, as in FIG. 3F, an electrode layer 17 is formed.

The above process gives MEA. A diffusion electrode (not shown) is fitted to the MEA to construct a DMFC-type fuel cell.

In this constitution, the proton-conductive film comprises a silicon-oxygen crosslinked structure in which columnar pores with a silanol group formed in their inner wall are regularly aligned, and therefore, it has a high mechanical strength and does not swell. In addition, since the pores is coated with a silanol group and the pore size is small and since the film does not swell, the film may keep its proton conductivity with almost no methanol crossover therein, and the film has high efficiency and high reliability.

Before calcination, the film may be subjected to TEOS vapor treatment, whereby the volume shrinkage in calcination may be reduced and the silica skeleton may be toughened, whereby the mechanical strength of the film may be further increased.

In this embodiment, the proton-conductive film is formed of an inorganic structure that comprises, as the principal component thereof, a crosslinked structure containing a silicon-oxygen bond. Apart from it, however, the film may comprise a crosslinked structure of an organic-inorganic hybrid structure that contains an organic group in the silicon-oxygen skeleton.

In this embodiment, the inner wall of the pores is modified with a silanol group as in FIG. 2A, but it may be modified with a phosphoryl group as in FIG. 2B.

Next, the characteristics of the proton-conductive film are analyzed through X-ray diffractiometry (XRD), FT-IR, FRA, methanol (MeOH) adsorptiometry and N₂ adsorptiometry.

In addition to the film of the above Embodiment 1 in which the inner wall of the pores is modified with a silanol group, another film is constructed in which the inner wall of the pores is modified with a phosphoryl group in place of a silyl group.

The test results of these are described. (ii) a film where the inner wall of the pores is modified with a silanol group, and (i) a film where the inner wall of the pores is modified with a phosphoryl group are prepared and analyzed.

XRD of the thin films produced according to the methods (i) and (ii) is in FIGS. 6A and 6B. a indicates after coating; b indicates after VI treatment; c indicates after calcination, d indicates after phosphorylation; e indicates after calcination; f indicates after silylation; g indicates after silylation followed by calcination. After spin-coating, both (i) and (ii) give peaks that may be assigned to the hexagonal structure, and it is known that the regular structure is still kept as such even after silylation and phosphorylation.

(i) Pore Modification with Phosphoryl Group:

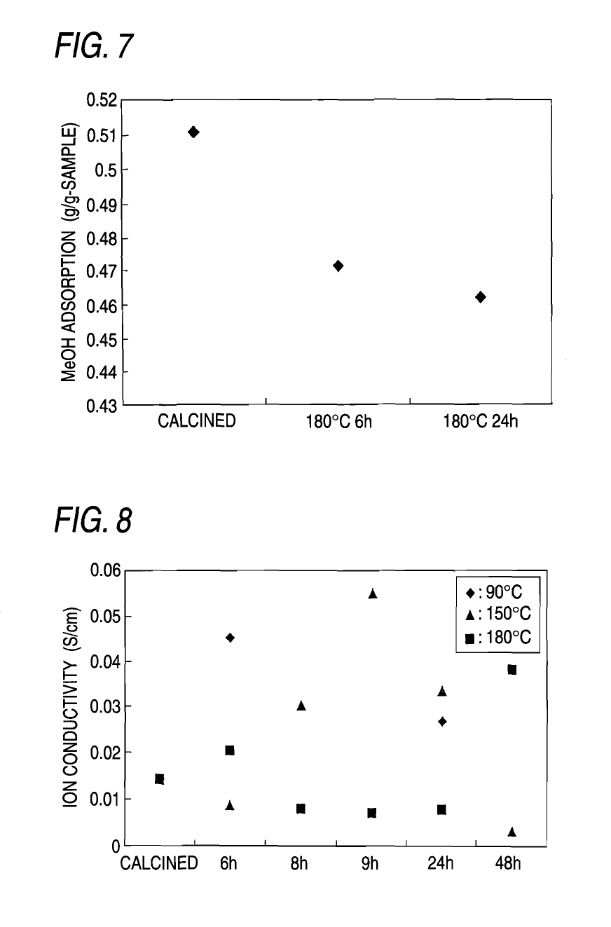

The synthesized samples are tested for MeOH adsorption. The result is shown in FIG. 7. After calcination, the samples are subjected to phosphorylation treatment at 180° C. for 6 hours or phosphorylation treatment at 180° C. for 24 hours, and are analyzed for their MeOH adsorption. As a result, it is confirmed that the increase in the phosphorylation time results in the reduction in the MeOH adsorption as compared with that just after calcination. This will be because the pore size and the pore volume may be reduced by the phosphorus-modification inside the pores. To confirm it, the samples are analyzed for N₂ adsorption, and the pore size therein is measured. As a result, before and after phosphorylation, the pore size is about 2 nm and 1.5 nm, respectively. The results confirm that the pores are modified with phosphorus inside them by phosphorylation inside them. It is understood that the result agrees with the MeOH adsorptiometry result.

The data of ion conductivity of the samples analyzed are shown in FIG. 8. The horizontal axis indicates the phosphorylation time; and the vertical axis indicates the ion conductivity. There is found no correlation between the treatment time and the ion conductivity. In addition, the data reproducibility is poor. This will be because the samples may be cracked and may differ from each other in point of their film quality, and these may have significant influences on the data.

### (ii) Pore Modification by Silylation:

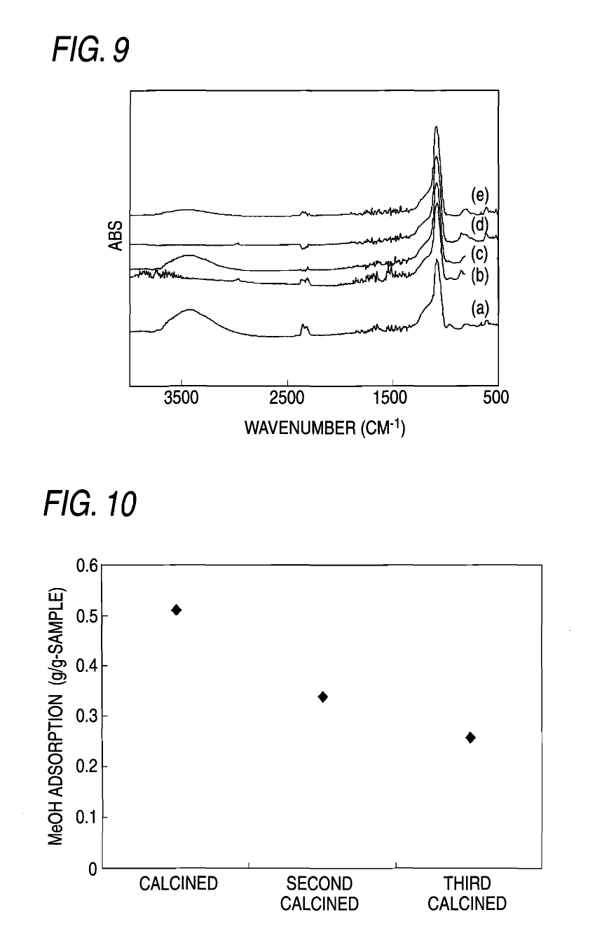

FIG. 9 shows IR spectra of synthesized samples. There are seen absorption bands at around 1100 cm⁻¹, 2900 cm⁻¹ and 3300 cm⁻¹, assigned to Si—O—Si, C—H, and —OH, respectively. From the results, it is confirmed that the silylation gives a band for a C—H bond and loses a band for an —OH bond. When a thin film after silylation is calcined, then it shows a phenomenon contrary to it. In other words, it may be considered that an organic group will be introduced into the pores by silylation and the film may be thereby hydrophobicated and, as a result, the number of the —OH groups in the film may reduce, and when the film in that condition is calcined at a high temperature, then the organic group may be decomposed and the number of the —OH groups in the film may increase. The same is seen in a case where silylation is carried out twice.

Next, the result of MeOH adsorptiometry is shown in FIG. 10. Like in the case of phosphorylation, the reduction in the MeOH adsorption is confirmed by modification inside the pores with an organic group. Further, it is also confirmed that repeating the silylation twice results in further reduction in the adsorption. From this, it is considered that the pore size may be reduced more as a result of repetition of silylation. The pore size distribution is determined by N₂ adsorptiometry.

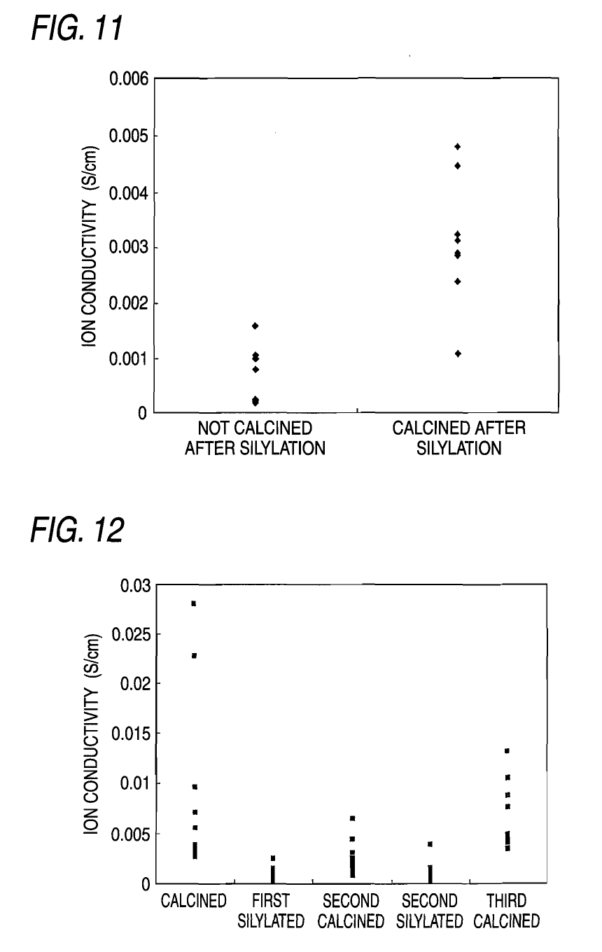

As a result, the pore size is 2 nm and 1.7 nm after one-time silylation and two-time silylation, respectively. From this, it may be considered that an organic group may be introduced into the pores through silylation and, when the organic group is decomposed by high-temperature calcination and when the decomposed part is further modified, then the pore size may be gradually reduced. The ion conductivity of the thin films produced according to the method is shown in FIG. 11 and FIG. 12. The data shown in these are ion conductivity data before and after calcination of silylated samples. From these, it is understood that the high-temperature calcination after silylation results in the increase in the ion conductivity as a whole, as compared with the case with no calcination. This will be because the organic group may be decomposed into an —OH group having ion conductivity, by the high-temperature calcination after silylation. FIG. 12 also shows the same tendency. It is confirmed that this tendency is still the same even after repetition of silylation.

The inside of the pores of synthesized mesoporous thin films is modified with phosphorus or an organic group, and the film are characterized in various aspects. The modification in any method has confirmed the reduction in the pore size and the reduction in the MeOH adsorption. In this experiment, C₁₆TAB is used as a template in the powder samples. There may be a possibility that samples synthesized by the use of Brij30 would show a different behavior. Accordingly, it is necessary to prepare powder samples by the use of Brij30 and to analyze them. Regarding the thin films modified by phosphorylation, there could not be found any satisfactory correlation between the treatment time and the electric conductivity of the samples. Regarding those modified with an organic group, the number of —OH groups in the films increases by high-temperature calcination after silylation and the electric conductivity of the films increases. However, there are still some problems in the reproducibility in measurement of the electric conductivity of these samples.

### Embodiment 2

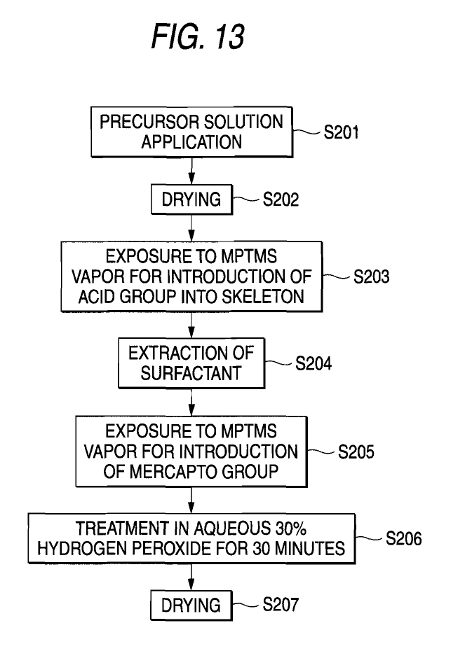

In the above Embodiment 1, the films are silylated after calcination. However, this embodiment is characterized in that silylation is first carried out prior to surfactant extraction by calcination, whereby an acid group (mercapto group) is introduced into the silicon-oxygen skeleton of a film, and thereafter the surfactant is extracted out by treatment with hydrochloric acid, as in FIG. 13 showing the flowchart of the process.

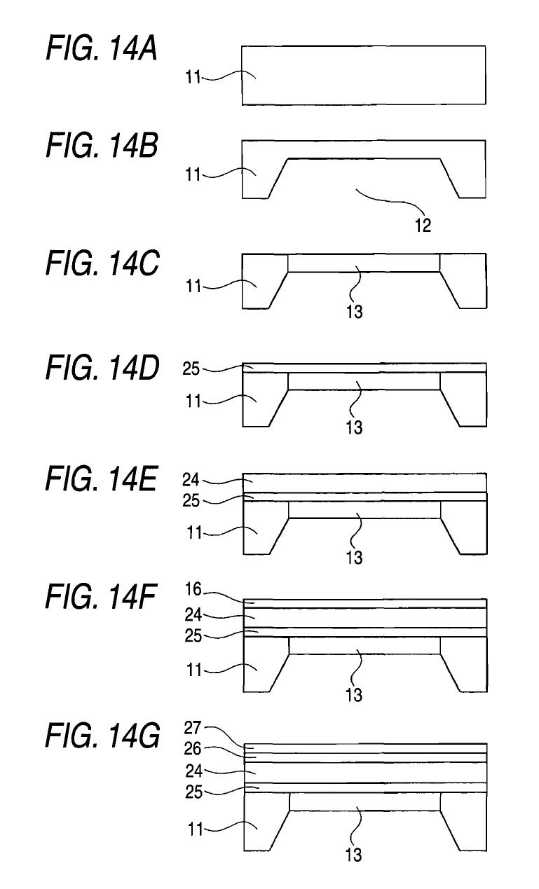

As in the flowchart shown in FIG. 13, a surfactant, cationic cetyltrimethylammonium bromide (C₁₆TAB: C₁₆H₃₃N⁺(CH₃)₃Br), a silica derivative, TEOS (tetraethoxysilane), and an acid catalyst, hydrochloric acid (HCl) are dissolved in a mixed solvent of H₂O/Et-OH (water-alcohol) to prepare a precursor solution in a mixer chamber. The molar ratio of the components as mixed to constitute the precursor solution is H₂O:Et-OH:HCl:C₁₆TB:TEOS=100:76:5:0.5:3. The mixture solution is applied onto the surface of the silicon substrate with a porous silicon 13 formed therein as in FIG. 14, using a spinner (FIG. 13, step 201), and dried at 90° C. for 5 minutes (FIG. 13, step 202), whereby the silica derivative is polymerized through hydrolytic polycondensation (pre-crosslinking step) to form a periodic self-aggregate of the surfactant.

The self-aggregate forms a spherical micelle structure with plural molecules aggregated therein, in which one molecule is C₁₆H₃₃N⁺(CH₃)₃Br; and with the increase in the aggregation degree thereof as a result of the increase in the concentration thereof, the parts from which the methyl group is dropped off form pores and the pores are aligned to constitute a crosslinked structure.

Then, this is exposed to MPTMS vapor whereby an acid group is introduced also into the silicon-oxygen skeleton (FIG. 13, step 203), washed with water and dried. The surfactant is extracted out with hydrochloric acid (FIG. 13, step 204), and the template, surfactant is completely decomposed and removed to give a pure mesoporous silica thin film. Then, this is again treated with MPTMS vapor at 180° C. for 4 hours (FIG. 13, step 205), to thereby form a silicon-oxygen crosslinked structure with a mercapto group bonding thereto. After it, this is heat-treated in aqueous 30% hydrogen peroxide for 30 minutes (FIG. 13, step 206), and dried (FIG. 13, step 207).

According to this method, an acid group may be introduced prior to the removal of surfactant, and therefore, in addition to the effect of the above-mentioned Embodiment 1, a larger number of acid groups may be introduced into the film of this embodiment, and a proton-conductive film having higher reactivity may be obtained.

The composition of the precursor solution is not limited to those given to the above-mentioned embodiments. Preferably, the surfactant may be from 0.01 to 0.1, the silica derivative may be from 0.01 to 0.5, and the acid catalyst may be from 0 to 5, based on the solution of 100. Using the precursor solution having the constitution, films may be formed having cylindrical pores.

In the above-mentioned embodiments, a cationic surfactant, cetyltrimethylammonium bromide (CTAB: C₁₆H₃₃N⁺(CH₃)₃Br⁻) is used, to which, however, the invention is not limited. Needless-to-say, any other surfactant may be used herein.

However, an alkali ion such as Na ion is unsuitable as a catalyst for semiconductor materials as it deteriorate them. Therefore, it is desirable that a cationic surfactant is used and an acid catalyst is used herein. The acid catalyst usable herein includes HCl, as well as nitric acid (HNO₃), sulfuric acid (H₂SO₄), phosphoric acid (H₃PO₄) and H₄SO₄.

The silica derivative for use herein is not limited to hydrogen silosesquioxane (HSQ) and methyl silosesquioxane (MSQ), and any one having a 4-membered or more poly-membered siloxane skeleton is usable herein.

As the solvent, water (H₂O)/alcohol mixed solvent is used, but water alone may also be used.

As the calcination atmosphere, a nitrogen atmosphere is used, but the calcination may be carried out under reduced pressure or in air. Preferably, a forming gas comprising a mixed gas of nitrogen and hydrogen is used, in which the moisture resistance of the film formed may be improved and the leak current through the film may be reduced.

In addition, the ratio of the surfactant, the silica derivative, the acid catalyst and the solvent may be suitably varied.

In the pre-polymerization step, the system is kept at 30 to 150° C. for 1 to 120 hours, but is preferably at 60 to 120° C., more preferably at 90° C.

The calcination step is carried out at 500° C. for 6 hours, but may be at 250° C. to 500° C. for 1 to 8 hours or so. Preferably, it is at 350° C. to 450° C. for 6 hours or so.

Even the same treatment may give different results depending on the presence or absence of surfactant. Specifically, in the step of carrying out the MPTMS treatment prior to the removal of surfactant (step 203), the silylating agent penetrates into silica since surfactant exists around it, and it modifies the silica. On the other hand, in the MPTMS treatment step (step 205) after the removal of surfactant, the silylating agent diffuses inside the pores and modified the surface of the pores.

### Embodiment 3

In the above Embodiment 1, the formation of the catalyst layer is attained by electrophoresis. In this embodiment, however, it may be attained by plating, as in the process chart of FIGS. 14A to 14G.

As in FIGS. 14A to 14C, a silicon substrate 11 is processed and thinned in the same manner as in the above Embodiment 1 to prepare a porous silicon 13.

Next, as in FIG. 14D, a catalyst layer 25 of a metal including platinum is formed by plating on the porous silicon 13.

Next, as in FIG. 14E, a mesoporous silica thin film (proton-conductive film) 24 is formed in which columnar pores are periodically aligned to be vertical to the surface of the silicon substrate and in which the inner wall of the pores is modified with a silanol group, like in the above Embodiment 1.

Further after this, as in FIG. 14F, a catalyst layer 26 of a metal including platinum is formed on the proton-conductive film 24, by plating.

As in FIG. 14G, a carbon particles-containing paste is applied to the surface of the catalyst layer, and calcined to form an electrode layer 27 thereon.

The process gives MEA.

### Embodiment 4

In the above Embodiment 1, the mesoporous silica thin film is formed according to a spin-coating method. However, it is not limited to such a spin-coating method, but a dipping method may also be employed.

Specifically, a surfactant, cationic cetyltrimethylammoniumbromide (CTAB: C₁₆H₃₃N⁺(CH₃)₃Br), a silica derivative, hydrogen silosesquioxane (HSQ), and an acid catalyst, hydrochloric acid (HCl) are dissolved in a mixed solvent of H₂O/alcohol to prepare a precursor solution in a mixer chamber. The blend ratio by mol of the precursor solution is as follows: The surfactant 0.5, the silica derivative 0.01 and the acid catalyst 2, relative to the solvent 100, are mixed. A silicon substrate 11 with a porous silicon 13 formed therein is dipped in the mixture solution in the mixer chamber, then the chamber is closed and kept heated at 30 to 150° C. for 1 to 120 hours, whereby the silica derivative is polymerized through hydrolytic polycondensation (pre-crosslinking step), and a periodic self-aggregate of the surfactant is thereby formed.

The self-aggregate forms a spherical micelle structure with plural molecules aggregated therein, in which one molecule is C₁₆H₃₃N⁺(CH₃)₃Br; and with the increase in the aggregation degree thereof as a result of the increase in the concentration thereof, the parts from which the methyl group is dropped off form pores and the pores are aligned to constitute a crosslinked structure.

Then, the substrate is pulled up, washed with water and dried, and thereafter this is heated and calcined in a nitrogen atmosphere at 400° C. for 3 hours, whereby the template, surfactant is completely pyrolyzed and removed to give a pure mesoporous silica thin film.

### Embodiment 5

In the above Embodiment 1, the mesoporous silica thin film is formed according to a spin-coating method. However, it is not limited to such a spin-coating method, but a dipping method may also be employed.

Specifically, a substrate is dipped in a prepared precursor solution by sinking it into the solution at a speed of from 1 mm/sec to 10 m/sec with the substrate being kept perpendicular to the liquid surface of the solution, and it is kept as such for 1 second to 1 hour.

Then, after a predetermined period of time, the substrate is perpendicularly pulled up at a speed of from 1 mm/sec to 10 m/sec and taken out of the solution.

Finally, this is calcined to thereby completely pyrolyze and remove the surfactant to give a pure dual-porous silica thin film, like in the above Embodiment 1.

In these embodiments of the invention, the mesoporous thin films produced have columnar pores periodically aligned therein, but the pore size and pore alignment mode in the films are not limited to those in these embodiments but may be varied in any desired manner.

As the catalyst, Brij30 (C₁₂H₂₅(OCH₂CH₂)₄OH and others may also be used herein in addition to C₁₆TAB.

As the surfactant, Pluronic F127® may be used. Using it, a thin film having a three-dimensional pore structure may be produced.

In the above-mentioned embodiments, the crosslinked structure formed in the films has a silicon-oxygen bond. In addition to it, any other metal-oxygen crosslinked structure such as a titanium-oxygen crosslinked structure may be formed in the films.

Further, for the acid group bonding to the silicon-oxygen crosslinked structure and participating in proton conduction (ion conduction), phosphoric acid (H₃PO₄) and perchloric acid (HClO₄) may be used in addition to sulfonic acid.

As described hereinabove, the invention is effective for application to DMFC-type fuel cells, and may be effectively utilized as a power sources for small-sized appliances such as portable phones, notebook-size personal computers, etc.

1-6. (canceled)

7. A method for producing a proton-conductive film, comprising:
a step of preparing a precursor solution containing a metal-oxygen derivative and a surfactant,
a crosslinking step of crosslinking the precursor solution to form a crosslinked structure,
a removing step of decomposing and removing the surfactant from the crosslinked structure obtained in the crosslinking step to form a mesoporous thin film which has, as the principal component thereof, a crosslinked structure having a metal-oxygen skeleton with an acid group bonding to at least a part thereof, and in which the pores are periodically aligned,
a step of adding a modifying group to the surface of the pores.

8. The method for producing a proton-conductive film as claimed in claim 7, wherein
the step of adding comprises:
a step of silylating the mesoporous thin film to modify the surface of the pores with a silyl group,
a calcining step of calcining the mesoporous thin film to convert the silyl group in the surface of the pores to a silanol group.

9. The method for producing a proton-conductive film as claimed in claim 7, wherein the addition step comprises:
a step of phosphorylating the mesoporous thin film to modify the surface of the pores with a P—OH group,
a calcining step of calcining the mesoporous thin film to make the surface of the pores have a P—OH group.

10. The method for producing a proton-conductive film as claimed in claim 7, wherein
the addition step comprises:
the modifying step and the calcining step that are carried out plural times to control the pore size to a desired one.

11. The method for producing a proton-conductive film as claimed in claim 8, wherein
the modification step comprises:
a step of contacting the pore surface with a vapor of trimethylethoxysilane.
